(19) United States
(12) Patent Application Publication
(10) Pub. No.: US 2018/0225455 A1
(43) Pub. Date: Aug. 9, 2018

(54) SCANNING OF WIRELESS NETWORK TRAFFIC IN VIRTUALIZED DOMAINS

(71) Applicant: HEWLETT-PACKARD DEVELOPMENT COMPANY, L.P., Houston, TX (US)

(72) Inventors: MARAT NERSISYAN, Palo Alto, CA (US); RICHARD A. BRAMLEY, Jr., Mansfield, MA (US); SANDEEP SUKHIJA, Palo Alto, CA (US)

(21) Appl. No.: 15/748,471

(22) PCT Filed: Jan. 31, 2016
(86) PCT No.: PCT/US2016/015862

§ 371 Date: Jan. 29, 2018

(51) Int. Cl. G06F 21/56; H04L 29/06; G06F 9/455

(52) U.S. Cl. CPC G06F 21/566; H04L 63/1425; H04L 63/1416; G06F 2009/45595; G06F 9/45558; G06F 2009/45587; G06F 9/4555

(57) ABSTRACT

A computing device includes at least one processor and a machine-readable storage medium storing instructions. The instructions may be executable by the hardware processor to execute a guest domain comprising a guest operating system and a frontend wireless device driver; execute a control domain comprising a backend wireless device driver; transmit wireless network commands and network packets across a dedicated data path from the frontend wireless device driver in the guest domain to a backend wireless device driver in the control domain; and scan, using in the backend wireless device driver, the network packets transmitted across the dedicated data path to detect a possible malware attack in the guest domain.

### BACKGROUND

Virtualization technology enables a computer system to execute one or more virtual machines. A virtual machine may be an abstraction of a physical computer, and may execute with some isolation from other virtual machine executing on the same physical computer. In some examples, each virtual machine may execute an operating system and/or application programs. Further, in some examples, a virtual machine may include virtualized components representing the hardware components of the virtual machine. The virtual machines may be created and controlled by a hypervisor.

### BRIEF DESCRIPTION OF THE DRAWINGS

Some implementations are described with respect to the following figures.

FIG. 1 is a schematic diagram of an example system, in accordance with some implementations.

FIGS. 2A-2B are example diagrams of a dedicated data path in accordance with some implementations.

FIG. 3 is a schematic diagram of an example computing device, in accordance with some implementations.

FIG. 4 is a flow diagram of an example process in accordance with some implementations.

FIG. 5 is a diagram of an example machine-readable storage medium storing instructions in accordance with some implementations.

### DETAILED DESCRIPTION

A computing device may use virtualization software to implement multiple domains. As used herein, the term “domain” refers to an abstraction of a physical computer such as a virtual machine. The virtualization software may implement a hypervisor, a control domain, and any number of guest domains. The control domain is defined as the most privileged domain, and the guest domains may be defined as unprivileged domains. For example, the control domain may be the only domain with direct access to the hardware resources of the computing device, and may have the ability to manage the guest domains. In contrast, the guest domains may not have direct access to the hardware resources of the computing device. For example, the guest domains do not have direct access to the control settings for a wireless network interface of a computing device.

In a virtualized environment, each guest domain can represent a virtual machine, and thus may come under a malware attack (viruses, spyware, adware, etc.) in a similar manner to a malware attack on a physical computer. As such, a guest domain may include protection applications (e.g., anti-virus software) to respond to malware attacks. However, some malware may attack and disable the protection application itself, thus rendering the guest domain to be vulnerable to the attack.

In accordance with some implementations, examples are provided for monitoring of wireless network traffic in a virtualized environment. As described further below, some implementations may include transmitting commands and network packets across a dedicated data path from a frontend wireless device driver in a guest domain to a backend wireless device driver in a control domain. A management agent in the control domain can monitor the network packets transmitted across the dedicated data path to detect possible malware attacks in the guest domain. Accordingly, some implementations can detect attacks that may not be detected by a protection application that has been compromised by malware.

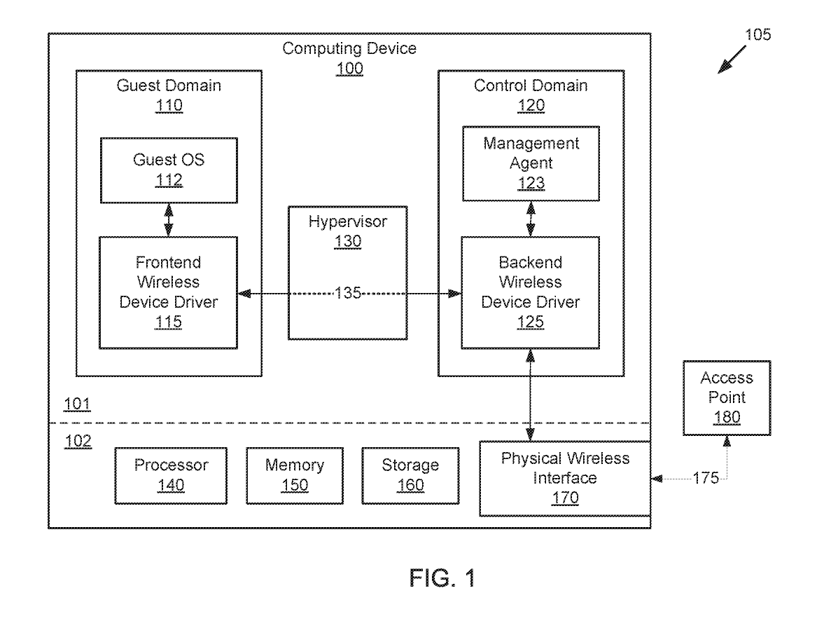

FIG. 1 is a schematic diagram of an example system 105, in accordance with some implementations. As shown, the example system 105 may include a computing device 100 and an access point 150. The computing device 100 may be, for example, a computer, a portable device, a tablet, a network client, a communication device, a printer, etc.

As illustrated in FIG. 1, the computing device 100 can include virtualized resources 101 and hardware resources 102. The hardware resources 102 may include a processor 140, memory 150, machine-readable storage 160, and a wireless network interface 170. The processor 140 can include a microprocessor, microcontroller, processor module or subsystem, programmable integrated circuit, programmable gate array, multiple processors, a microprocessor including multiple processing cores, or another control or computing device. The memory 150 can be any type of computer memory (e.g., dynamic random access memory (DRAM), static random-access memory (SRAM), etc.). The machine-readable storage 160 can include non-transitory storage media such as hard drives, flash storage, optical disks, etc. In some implementations, the computing device 100 may also include a wired interface (not shown).

The wireless network interface 170 can provide inbound and outbound wireless network communication. The wireless network interface 170 can use a wireless network standard or protocol, such as the Institute of Electrical and Electronics Engineers (IEEE) 802.11 standards. In some implementations, the network interface 170 may enable the computing device 100 to establish a wireless network connection 175 with an access point 180, and thereby connect to a larger network.

As shown in FIG. 1, the virtualized resources 101 may include a guest domain 110, a control domain 120, and a hypervisor 130. The hypervisor 130 can launch the control domain 120. Further, the hypervisor 130 can perform memory management and CPU scheduling for all domains. The control domain 120 is the most privileged domain (e.g., “dom0”), and may be the only domain that has direct access to the hardware resources 102. Further, the control domain 120 can manage the hypervisor 130, and can also launch unprivileged domains such as the guest domain 110. As shown, the control domain 120 can include a management agent 123 and a backend wireless device driver 125.

In some implementations, the guest domain 110 can include a guest operating system (OS) 112 and a frontend wireless device driver 115. The guest OS 112 may include a native framework for interacting with a wireless network interface. For example, the native framework may include control commands for managing and configuring wireless interface devices. Further, the native framework can enable the guest OS 112 to send and receive network data packets to/from remote network devices. In some examples, the native framework is a native IEEE 802.11 framework.

In some implementations, the guest OS 112 is a standard OS that is not modified to operate in a virtualized environment. As such, the frontend wireless device driver 115 appears to the guest OS 112 as a physical wireless interface device. For example, the guest OS 112 may send a set of wireless interface control commands to the frontend wireless device driver 115. Further, the guest OS 112 may send a set of wireless network packets to the frontend wireless device driver 115.

In some implementations, the frontend wireless device driver 115 is a paravirtualized driver that operates by interacting with the backend wireless device driver 125. In some implementations, the frontend wireless device driver 115 communicates with the backend wireless device driver 125 through a dedicated data path 135 via the hypervisor 130. In some implementations, the dedicated data path 135 may use hypervisor shared memory pages. Further, the dedicated data path 135 may use a first input/output (I/O) ring for inbound traffic, and a second I/O ring for outbound traffic.

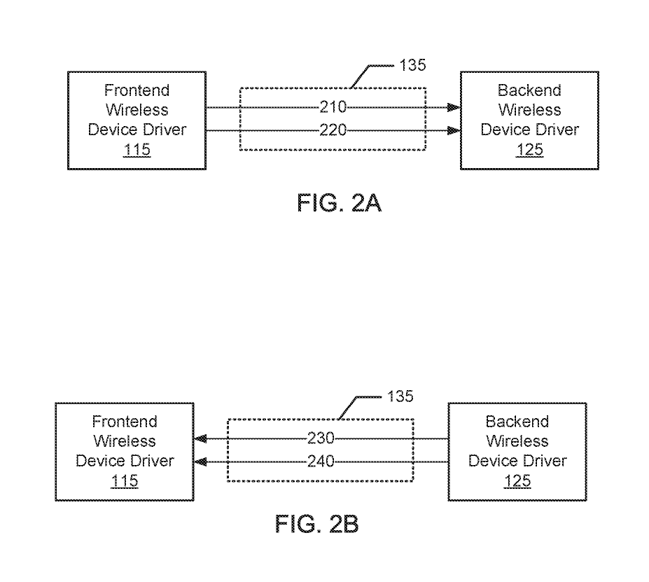

Referring now to FIGS. 2A-2B, shown are example diagrams of a dedicated data path 135 in accordance with some implementations. Specifically, as shown in FIG. 2A, the dedicated data path 135 can transmit control commands 210 and outbound network packets 220 from the frontend wireless device driver 115 to the backend wireless device driver 125. In some implementations, the backend wireless device driver 125 is a paravirtualized driver that controls and/or configures the wireless network interface 170 (shown in FIG. 1) based on the control commands 210 received from the frontend wireless device driver 115. For example, the backend wireless device driver 125 may control the wireless network interface 170 to log on to the access point 180 or to another device (not shown). Further, in some implementations, the backend wireless device driver 125 causes the wireless network interface 170 to transmit the outbound network packets 220 received from the frontend wireless device driver 115.

Referring now to FIG. 2B, the dedicated data path 135 can transmit responses 230 and inbound network packets 240 from the backend wireless device driver 125 to the frontend wireless device driver 115. For example, the responses 230 may include log-on messages or acknowledgements, device status information, wireless signal information, and so forth. In some implementations, the frontend wireless device driver 115 provides the responses 230 and/or the inbound network packets 240 to the guest OS 112 (shown in FIG. 1).

Referring again to FIG. 1, the management agent 123 can monitor the network packets transmitted by the dedicated data path 135 between the frontend wireless device driver 115 and the backend wireless device driver 125. In some implementations, the management agent 123 can scan and analyze the network packets to detect possible malware attacks. For example, the management agent 123 may analyze the network packets using signature analysis, heuristic analysis, behavior analysis, blacklists, and so forth. In some implementations, the management agent 123 may respond to a detection of possible malware by triggering an alarm, raising an exception, triggering a remedial action (e.g., locking or freezing the guest domain 110), and so forth.

As shown, the management agent 123 may monitor the network packets using the backend wireless device driver 125. For example, in some implementations, the management agent 123 may use an application programming interface (API) of the backend wireless device driver 125 to monitor inbound and outbound network packets transmitted via the dedicated data path 135. Further, in some implementations, the management agent 123 can also use the API of the backend wireless device driver 125 to monitor the state and/or transactions of the wireless network interface 170. In some implementations, the management agent 123 may be dedicated to monitor only inbound and outbound network packets that are transmitted via be the dedicated data path 135. In other implementations, the management agent 123 may also monitor inbound and outbound network packets of the guest OS 112 that are transmitted across a wired interface (not shown) of the computing device 100. For example, in some implementations, the management agent 123 can access a backend wired device driver (not shown) in the control domain 120 to monitor packets transmitted to/from a frontend wired device driver (not shown) in the guest domain 110.

In some implementations, the backend wireless device driver 125 may control the wireless network interface 170 to transmit the set of network packets based on the set of commands received from the frontend wireless device driver 115. For example, the wireless network interface 170 may send and/or receive network packets based on one or more commands specifying a security credential, a connection setting, a broadcast setting, and so forth.

In some implementations, the frontend wireless device driver 115, the dedicated data path 135, and the backend wireless device driver 125 do not modify the protocol format of the network packets. For example, if the guest OS 112 issues outbound network packets in a IEEE 802.11 format, the packets remain in that format as they pass through the frontend wireless device driver 115, the dedicated data path 135, and the backend wireless device driver 125.

Note that, while FIG. 1 shows an example implementation, other implementations are possible. For example, the computing device 100, the control domain 120, and/or the guest domain 110 may include other components in addition to (or instead of) the components shown in FIG. 1. Further, the computing device 100 may include any number of guest domains 110. In another example, it is contemplated that the management agent 123 may be included in the backend wireless device driver 125. Other combinations and/or variations are also possible.

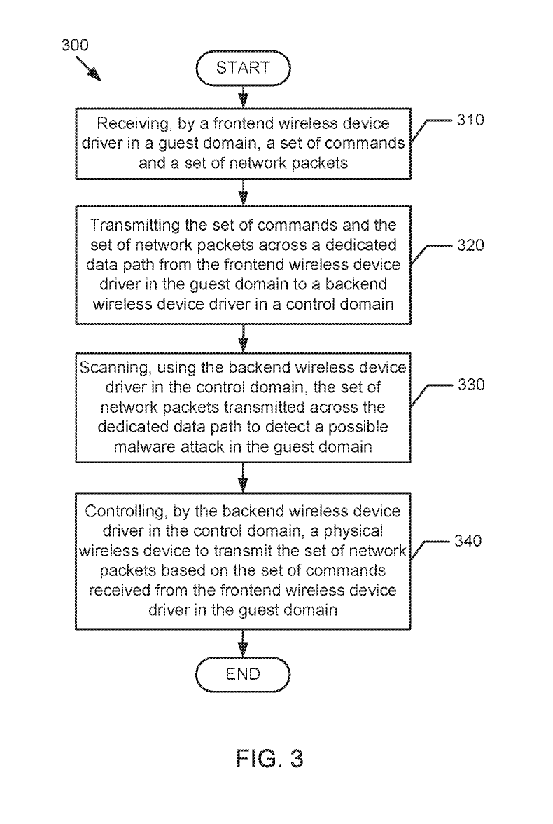

Referring now to FIG. 3, shown is a process 300 for classifying an application event, in accordance with some implementations. The process 300 may be performed by the computing device 100 shown in FIG. 1. The process 300 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 300 may be described below with reference to FIGS. 1-2B, which show examples in accordance with some implementations. However, other implementations are also possible.

At block 310, a set of commands and a set of network packets may be received by a frontend wireless device driver in a guest domain. For example, referring to FIG. 1, the guest domain 110 includes the frontend wireless device driver 115 and the guest OS 112. The frontend wireless device driver 115 may receive wireless interface control commands and wireless network packets from the guest OS 112. In some implementations, the commands and network packets may conform to a IEEE 802.11 standard.

At block 320, the set of commands and the set of network packets may be transmitted across a dedicated data path from the frontend wireless device driver in the guest domain to a backend wireless device driver in a control domain. For example, referring to FIG. 1, the commands and network packets may be transmitted across the dedicated data path 135 between the frontend wireless device driver 115 in the guest domain 110 and the backend wireless device driver 125 in the control domain 120. In some examples, the dedicated data path 135 may use shared memory pages of the hypervisor 130.

At block 330, the set of network packets transmitted across the dedicated data path may be scanned using the backend wireless device driver in the control domain to detect a possible malware attack in the guest domain. For example, referring to FIG. 1, the management agent 123 in the control domain 120 can monitor the network packets transmitted by the dedicated data path 135 to detect network traffic that indicates a possible malware attack in the guest domain 110. In some examples, the management agent 123 may use an API of the backend wireless device driver 125 to monitor the network packets. Further, in some examples, the management agent 123 may use the API of the backend wireless device driver 125 to monitor the state and/or transactions of the wireless network interface 170.

At block 340, a physical wireless device may be controlled by the backend wireless device driver in the control domain to transmit the set of network packets based on the set of commands received from the frontend wireless device driver in the guest domain. For example, referring to FIG. 1, the backend wireless device driver 125 may control the wireless network interface 170 to transmit the set of network packets based on the set of commands received from the frontend wireless device driver 115. After block 340, the process 300 is completed.

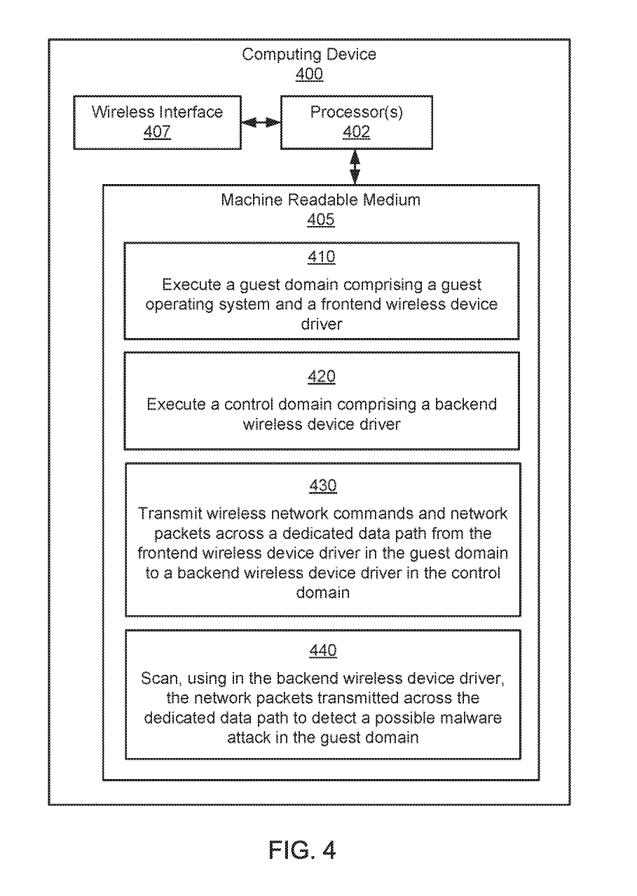

Referring now to FIG. 4, shown is a schematic diagram of an example computing device 400. In some examples, the computing device 400 may correspond generally to the computing device 100 shown in FIG. 1. As shown, the computing device 400 can include a hardware processor(s) 402, a machine-readable storage medium 405, and a wireless interface 407. The machine-readable storage medium 405 may store instructions 410-440. The instructions 410-440 can be executed by the hardware processor(s) 302.

As shown, instruction 410 may execute a guest domain comprising a guest operating system and a frontend wireless device driver. Instruction 420 may execute a control domain comprising a backend wireless device driver.

Instruction 430 may transmit wireless network commands and network packets across a dedicated data path from the frontend wireless device driver in the guest domain to a backend wireless device driver in the control domain. Instruction 440 may scan, using in the backend wireless device driver, the network packets transmitted across the dedicated data path to detect a possible malware attack in the guest domain.

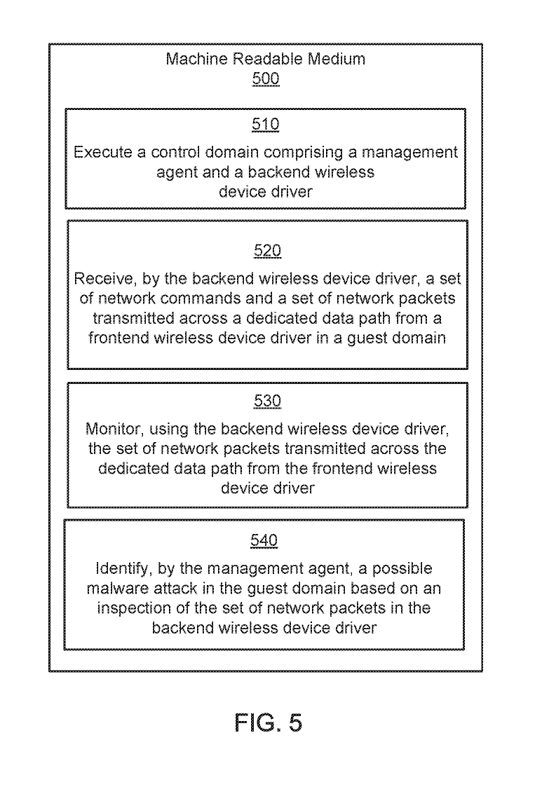

Referring now to FIG. 5, shown is a machine-readable storage medium 500 storing instructions 510-540, in accordance with some implementations. The instructions 510-540 can be executed by any number of processors (e.g., the processor 110 shown in FIG. 1). The machine-readable storage medium 500 may be any non-transitory computer readable medium, such as an optical, semiconductor, or magnetic storage device.

As shown, instruction 510 may execute a control domain comprising a management agent and a backend wireless device driver. Instruction 520 may receive, by the backend wireless device driver, a set of network commands and a set of network packets transmitted across a dedicated data path from a frontend wireless device driver in a guest domain.

Instruction 530 may monitor, using the backend wireless device driver, the set of network packets transmitted across the dedicated data path from the frontend wireless device driver. Instruction 540 may identify, by the management agent, a possible malware attack in the guest domain based on an inspection of the set of network packets in the backend wireless device driver.

In accordance with some implementations, techniques or mechanisms are provided for monitoring wireless network traffic in a virtualized environment. Some implementations include transmitting commands and network packets across a dedicated data path from a frontend wireless device driver in a guest domain to a backend wireless device driver in a control domain. Further, a management agent in the control domain may monitor the network packets transmitted across the dedicated data path to detect possible malware attacks in the guest domain. Accordingly, some implementations may detect attacks that would not be detected by compromised protections in the guest domain.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
a hardware processor; and
a machine-readable storage medium storing instructions, the instructions executable by the hardware processor to:
execute a guest domain comprising a guest operating system and a frontend wireless device driver;
execute a control domain comprising a backend wireless device driver;
transmit wireless network commands and network packets across a dedicated data path from the frontend wireless device driver in the guest domain to a backend wireless device driver in the control domain; and
scan, using in the backend wireless device driver, the network packets transmitted across the dedicated data path to detect a possible malware attack in the guest domain.

2. The computing device of claim 1, further comprising a physical wireless interface device.

3. The computing device of claim 2, the instructions further executable to:
send, by the backend wireless device driver in the command domain, the network packets to the physical wireless interface device; and
transmitting, by the physical wireless interface device, the network packets across a wireless connection to a wireless access point.

4. The computing device of claim 1, wherein the control domain is the only domain that has direct access to hardware resources of the computing device.

5. The computing device of claim 1, wherein the frontend wireless device driver receives the wireless network commands and the network packets from the guest operating system.

6. The computing device of claim 1, wherein the control domain further comprises a management agent, wherein the management agent is to scan inbound and outbound network packets transmitted across the dedicated data path.

7. The computing device of claim 1, wherein the dedicated data path uses shared memory pages of a hypervisor.

8. A method comprising:
receiving, by a frontend wireless device driver in a guest domain, a set of commands and a set of network packets;
transmitting the set of commands and the set of network packets across a dedicated data path from the frontend wireless device driver in the guest domain to a backend wireless device driver in a control domain;
scanning, using the backend wireless device driver in the control domain, the set of network packets transmitted across the dedicated data path to detect a possible malware attack in the guest domain; and
controlling, by the backend wireless device driver in the control domain, a physical wireless device to transmit the set of network packets based on the set of commands received from the frontend wireless device driver in the guest domain.

9. The method of claim 8, further comprising:
controlling, by the backend wireless device driver, the physical wireless device to establish a wireless connection based on the set of commands received from the frontend wireless device driver in the guest domain.

10. The method of claim 9, wherein the control domain comprises a management agent, wherein the method further comprises:
scanning, by the management agent in the control domain, inbound and outbound network packets transmitted across the dedicated data path.

11. The method of claim 9, wherein the frontend wireless device driver receives the set of commands and the set of network packets from a guest operating system of the guest domain.

12. An article comprising a machine-readable storage medium storing instructions that upon execution cause a processor to:
execute a control domain comprising a management agent and a backend wireless device driver;
receive, by the backend wireless device driver, a set of network commands and a set of network packets transmitted across a dedicated data path from a frontend wireless device driver in a guest domain;
monitor, using the backend wireless device driver, the set of network packets transmitted across the dedicated data path from the frontend wireless device driver; and
identify, by the management agent, a possible malware attack in the guest domain based on an inspection of the set of network packets in the backend wireless device driver.

13. The article of claim 12, wherein the management agent uses an application programming interface (API) of the backend wireless device driver to monitor inbound and outbound network packets transmitted via the dedicated data path.

14. The article of claim 12, wherein the instructions further cause the processor to:
execute a plurality of domains in a virtualized environment, wherein the control domain and the guest domain are included in the plurality of domains.

15. The article of claim 14, wherein the instructions further cause the processor to:
transmitting, by a physical wireless device, the set of network packets to a wireless access point.
